(19) United States
(12) Patent Application Publication
(10) Pub. No.: US 2025/0376014 A1
(43) Pub. Date: Dec. 11, 2025

(54) Frame arrangement for a vehicle roof

(71) Applicant: Webasto SE, Stockdorf (DE)

(72) Inventors: Matthias BAUMANN, Stockdorf (DE); Andrei POPOVICI, Stockdorf (DE)

(21) Appl. No.: 19/225,071

(22) Filed: Jun. 2, 2025

(30) Foreign Application Priority Data
Jun. 6, 2024 (EP) 24180354.3

(51) Int. Cl. B60J 7/057; B60J 7/00; B60J 10/50; B60J 10/90

(52) U.S. Cl. CPC B60J 7/057; B60J 7/0015; B60J 10/50; B60J 10/90

(57) ABSTRACT

A frame arrangement for a vehicle roof for supporting a deployable and displaceable cover, having a frame element extending along a first main extension axis. The frame element has a main portion which lies in a first main extension plane which is spanned by the first main extension axis and a second main extension axis, and a first reinforcing portion, which is connected to the main portion and projects along a vertical axis from the first main extension plane. The frame arrangement may further have a first plastic guide rail having at least one receiving channel for a carriage, wherein the first plastic guide rail extends along the first main extension axis and the vertical axis, and wherein the first plastic guide rail at least partially surrounds the first reinforcing portion for stabilizing the first plastic guide rail.

### CROSS-REFERENCE TO RELATED APPLICATION

This application claims the benefit of EP Application Serial No. 24180354.3, filed Jun. 6, 2024, which is incorporated herein by reference in its entirety.

### TECHNICAL FIELD

The present disclosure relates to a frame arrangement for a vehicle roof for supporting a deployable and displaceable cover. The present invention further relates to a vehicle comprising a vehicle roof and such a frame arrangement which is fixedly coupled to the vehicle roof.

### BACKGROUND

In some motor vehicles, in order to provide a view out of the vehicle, a roof opening is integrated into the vehicle roof and is closed with a cover, in particular made of glass or plastic. If necessary, the cover of this roof arrangement is designed to be movable in order to allow air exchange in addition to a view. The cover can either close a roof opening in a closed position of the cover or at least partially open it in other positions. There are also roof arrangements with a roller blind device, also known as a darkening device, for use in a motor vehicle. Such roof arrangements have in common that a corresponding mechanism for actuating the movable cover and/or the roller blind device has guide rails in which elements of the mechanisms are displaceably guided. These guide rails are made of aluminum, for example, and are bolted to one or more roof frame elements of a frame arrangement.

It is desirable to create a frame arrangement for a vehicle roof that is more sustainable and cost-effective.

### SUMMARY

A frame arrangement for a vehicle roof for supporting a deployable and displaceable cover is provided. The frame arrangement comprises a frame element extending along a first main extension axis. The frame element comprises a main portion lying in a first main extension plane spanned by the first main extension axis and a second main extension axis. The frame element comprises a first reinforcing portion connected to the main portion and projecting along a vertical axis from the first main extension plane. The frame arrangement further comprises a first plastic guide rail with at least one receiving channel for a carriage, wherein the first plastic guide rail extends along the first main extension axis and the vertical axis and wherein the first plastic guide rail at least partially surrounds the first reinforcing portion for stabilizing the first plastic guide rail.

The frame arrangement surrounds a roof opening in the vehicle roof, for example. The frame arrangement carries a cover with the molded-on plastic guide rail. The cover is designed to close a vehicle opening in the vehicle roof. The vehicle roof, the cover and the frame arrangement are enclosed by a first longitudinal side of the vehicle, a second longitudinal side of the vehicle, a rear window and a windshield of a vehicle. The first main extension axis extends from the rear window to the windshield. The first longitudinal side of the vehicle connects the rear window and the windshield. The second longitudinal side of the vehicle is opposite the first longitudinal side of the vehicle and also connects the rear window and the windshield. The second main extension axis lies transverse to the first main extension axis and extends from the first longitudinal side of the vehicle to the second longitudinal side of the vehicle. The first main extension axis and the second main extension axis span a first main extension plane. The vehicle roof, the cover and the frame arrangement are arranged along the first main extension plane.

The frame arrangement comprises at least one frame element. For example, two frame elements are used in the frame arrangement. The at least one frame element extends along the first main extension axis. The frame element is arranged on the first longitudinal side of the vehicle. A further frame element is arranged along the second longitudinal side of the vehicle.

The frame element comprises the first main portion and the first reinforcing portion. The first main portion extends along the first main extension axis and the second main extension axis. The first reinforcing portion extends along the first main extension axis and a vertical axis that protrudes from the first main extension plane. The vertical axis is, for example, perpendicular or inclined to the first main extension plane.

The plastic guide rail extends along the first main extension axis, along which at least one receiving channel for a carriage extends. The carriage is designed to be guided in the first plastic guide rail and to be moved relative to the first plastic guide rail. The carriage has, for example, a main part and two side parts connected to it. The main part is arranged along the first main extension plane and the two side parts protrude from the main part along the vertical axis. The side parts are connected to the main part at a first end. In addition, the two side parts can each have a clamp-like holding portion at a second end of the carriage, which is opposite the first end along the vertical axis. The geometry of the carriage thus enables the carriage to engage in at least one receiving channel of the plastic guide rail with the holding portion. For example, the carriage engages in two receiving channels, which are located on both sides of the plastic guide rail along the first main extension axis, each with a holding portion. Alternatively, the carriage has only one holding portion that engages in a receiving channel.

The drive cable is coupled to the carriage. The drive cable is designed to transmit both tensile and shear forces to the carriage. In particular, the drive cable is designed to be resistant to tension and compression.

The first plastic guide rail makes it possible to realize recesses or areas for other functional assemblies. For example, water drains can also be integrated into the first plastic guide rail without the need for time-consuming reworking of the first plastic guide rail or additional assembly by means of fasteners.

The first plastic guide rail therefore replaces metal components, which reduces the weight of the entire frame arrangement. The use of the first reinforcing portion of the frame element to stabilize the first plastic guide rail leads to a lower weight with the same stability or to increased stability with the same weight compared to a guide rail made of aluminum. The first reinforcing portion therefore provides additional support for the first plastic guide rail, which creates a more stable frame arrangement overall.

The first reinforcing portion and the plastic guide rail together form a uniform assembly. The one-piece solution makes a significant contribution to increasing the rigidity, for example the torsional rigidity, and therefore the fatigue strength of the connection between the guide rail and frame element. The absence of additional components, such as fasteners, significantly increases the bending stiffness.

Advantageously, the first plastic guide rail improves sustainability, as the carbon footprint of a plastic guide rail is more positive than that of a metal guide rail. For example, the CO2 emissions of a guide rail made of plastic are reduced compared to guide rails made of aluminum. In addition, potential reworking of the first plastic guide rail is easier than reworking a metal guide rail. Advantageously, the additional material for the reinforcing portion of the frame element is provided from the remnants of the material produced during the manufacture of the frame arrangement. The additional material for the reinforcing portion is, for example, metal, in particular steel. The elimination of additional components, such as fasteners, also helps to prevent unwanted noises, such as creaking in the connection area.

According to at least one embodiment, the first plastic guide rail at least partially surrounds the main portion for stabilizing the first plastic guide rail.

The main portion further stabilizes the first plastic guide rail. The main portion also prevents the plastic guide rail from unintentionally slipping or sliding off the first reinforcing portion.

According to at least one embodiment, the first plastic guide rail is designed as an injection-molded component.

Injection-molded components have the advantage that the overmolded frame element means that no additional components are required for alignment between the frame element and the plastic guide rail. Such alignment or adjustment elements are therefore not required. Subsequent attachment of a separate intermediate piece to the plastic guide rail, such as a connection connector, for coupling with the frame element is also not necessary. Such an intermediate piece, also known as an adapter or connecting piece, would be mounted on the plastic guide rail in the area of a recess in the plastic guide rail, for example by means of a clamp connection. Such an intermediate piece would therefore cause assembly work and therefore higher costs. The frame element is therefore coupled directly to the plastic guide rail.

The plastic guide rail is manufactured in an injection molding process for easy shaping. The advantage of this is that little reworking of the plastic guide rail is required.

According to at least one embodiment, the first plastic guide rail comprises a guide rail channel for a drive cable.

The guide rail channel is integrated into the first plastic guide rail, for example, and is manufactured in one piece with the first plastic guide rail.

According to at least one embodiment, the guide rail channel is designed as an injection-molded component and embedded in the plastic guide rail.

For example, the guide rail channel is manufactured together with the plastic guide rail as an injection-molded component. Alternatively, the guide rail channel and the first plastic guide rail are separately manufactured injection-molded components and are joined together after manufacture. The guide rail channel is integrated into the plastic guide rail.

According to at least one embodiment, the guide rail channel is designed as an extrusion component and is embedded or inserted into the plastic guide rail.

Alternatively, the guide rail channel is designed as an undercut profile, roll-formed profile and/or continuous cast aluminum. The guide rail channel is, for example, a separate component that is produced by extrusion and subsequently inserted into the first plastic guide rail. This enables geometries that are difficult to realize using injection molding. For example, the opening of the guide rail channel, which is difficult to cast, is realized. The guide channel extruded in this way is inserted into a further recess in the first plastic guide rail, for example.

Alternatively, the first plastic guide rail and the guide rail channel are coextruded assemblies that are brought together by plastic melts of the same or different types.

The material used for the first plastic guide rail and/or the guide rail channel comprises, for example, polyurethane; abrasion-resistant thermoplastics are preferred. The thermoplastics used include polyethylene terephthalate (PET), polyether ether ketone (PPEK), polyamides (PA) or partially aromatic polyamides (PPA).

According to at least one embodiment, the guide rail channel comprises an extended region which extends the guide rail channel along the second main extension axis and which is configured to provide a guide and receptacle for a roller blind device or an acoustic seal or an inner canopy connection.

As a combined component that can accommodate and guide both a drive cable and a roller blind device, installation is simplified. The guide rail channel, which includes the extended region, can be subsequently inserted or integrated into the first plastic guide rail.

The extended region of the guide rail channel is not limited to guiding and holding roller blind devices. Alternatively or additionally, the extended region of the guide rail channel is suitable for accommodating and/or supporting other assemblies.

According to at least one embodiment, the frame element comprises a second reinforcing portion, which is connected to the main portion and extends the main portion along the second main extension axis, wherein the second reinforcing portion is arranged to stabilize the guide rail channel.

The second reinforcing portion is, for example, formed from the first reinforcing portion of the frame element. For example, part of the first reinforcing portion is punched out or cut out and bent over to create the second reinforcing portion. This allows the material of the frame element to be used almost completely. Additional fasteners, such as welds, rivets, screws, bolts or similar, can be dispensed with in order to create the reinforcing portions. This simplifies the manufacture and assembly of the frame element.

For example, the extended region of the guide rail channel is arranged on the second reinforcing portion. The extended region of the guide rail channel is supported at least on the second reinforcing portion. The extended region is alternatively or additionally glued to the second reinforcing portion or molded onto it by overmolding. The extended region is alternatively or additionally connected to the second reinforcing portion by means of material bonding methods. In this context, material bonding methods include, for example, welding, such as ultrasonic or friction stir welding. The material of the extended region comprises, for example, polyurethane, preferably abrasion-resistant thermoplastics. Thermoplastics used include polyethylene terephthalate (PET), polyether ether ketone (PPEK), polyamides (PA) or partially aromatic polyamides (PPA).

According to one exemplary embodiment, the second reinforcing portion is designed to accommodate a second plastic guide rail.

The second plastic guide rail is designed, for example, to accommodate and/or guide a roller blind device. The second plastic guide rail is arranged on the second reinforcing portion, for example. The second plastic guide rail is supported at least on the second reinforcing portion. The second plastic guide rail is alternatively or additionally glued to the second reinforcing portion or molded onto it by overmolding. The second plastic guide rail is alternatively or additionally attached to the second reinforcing portion by means of material bonding methods. In this context, material bonding methods include, for example, welding, such as ultrasonic or friction stir welding. The second plastic guide rail is, in particular, a separately manufactured component. The material of the second plastic guide rail comprises, for example, polyurethane, preferably thermoplastic. Thermoplastics used include, for example, polyethylene terephthalate (PET), polyether ether ketone (PPEK), polyamides (PA) or partially aromatic polyamides (PPA).

The second plastic guide rail is not limited to guiding and holding roller blind devices. Alternatively or additionally, the second plastic guide rail is suitable for accommodating and/or supporting other assemblies.

According to at least one embodiment, the frame element is shaped alternately along the main extension axis, so that along the first main extension axis the first reinforcing portion and the second reinforcing portion alternately protrude at least partially from the main portion.

To increase stability, the second reinforcing portion does not extend continuously along the first main extension axis and is interrupted along the first main extension axis. In the areas in which the second reinforcing portion protrudes from the main portion, the first reinforcing portion is at least partially present. Alternatively, no first reinforcing portion is present in the regions along the first main extension axis in which the second reinforcing portion protrudes from the main portion.

According to at least one embodiment, the frame element is made of metal or comprises such a material.

According to at least one embodiment, the frame element is made of steel or comprises such a material.

A metal or steel frame element is easy to produce, robust and dimensionally stable. The metal or steel frame element generates the necessary stability by projecting into the plastic guide rail.

According to at least one embodiment, the first reinforcing portion partially surrounds the at least one receiving channel and stabilizes the receiving channel.

In the event of an accident, in particular a head-on accident, i.e., a collision with an obstacle in the direction of travel, it is possible that the cover is accelerated relative to the vehicle to such an extent that the coupling between the cover and the first plastic guide rail is too weak to hold the cover in place. The first reinforcing portion provides additional stability for the at least one mounting channel in order to at least reduce this risk. In conjunction with the holding portions of the carriage, this prevents the cover from detaching from the vehicle roof.

The frame arrangement described has a small number of components and can therefore be realized with a small number of production or assembly steps. It can therefore be manufactured cost-effectively and in a time-saving manner and integrated into the area of a vehicle roof in a space-saving manner. As no additional coupling means and fasteners are required to couple the frame element and the plastic guide rails, less installation space is required in the vehicle for tool accessibility during assembly.

According to one aspect, a vehicle comprises a vehicle roof and a configuration of the frame arrangement described above, wherein the frame arrangement is fixedly coupled to the vehicle roof.

The motor vehicle substantially enables the above-mentioned advantages and functions.

### BRIEF DESCRIPTION OF DRAWINGS

Exemplary embodiments of the disclosure are explained in greater detail below with reference to the schematic drawings.

In the drawings:

FIG. 1 is a schematic representation of a part of a vehicle according to an exemplary embodiment,

FIG. 2 is a schematic sectional view of a frame arrangement according to an exemplary embodiment,

FIG. 3 is a schematic sectional view of a frame arrangement according to an exemplary embodiment,

FIG. 4 is a schematic representation of a frame element with guide rail and guide rail channel according to an exemplary embodiment,

FIG. 5 is a schematic representation of a frame element according to an exemplary embodiment,

FIG. 6 is a schematic sectional view of a frame arrangement according to an exemplary embodiment.

Elements of the same design and function are marked with the same reference signs across all figures.

### DETAILED DESCRIPTION

In this description, terms such as “top”, “bottom”, “upper side”, “underside”, “inside” and “outside”, “front” and “rear” refer to alignments and orientations as illustrated in the figures and are common in an operational motor vehicle.

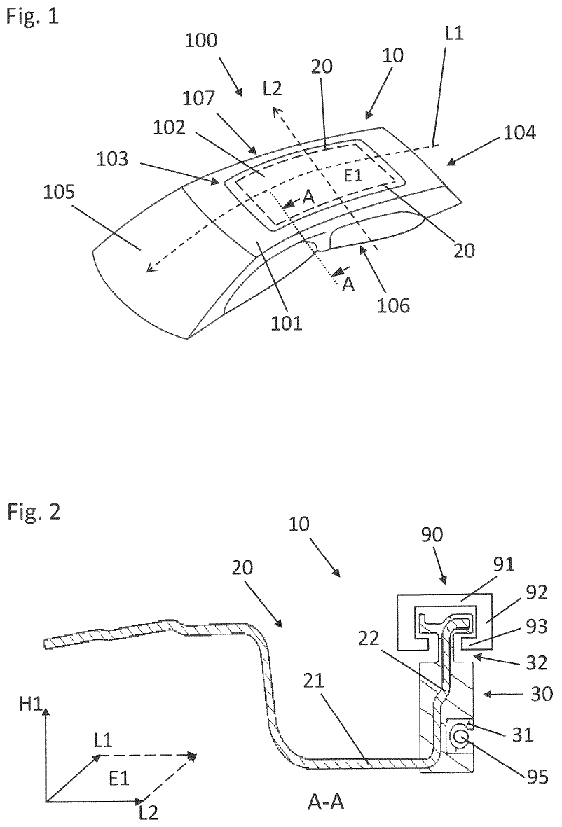

FIG. 1 shows a frame arrangement 10 for a vehicle roof 101 of a vehicle 100, which, for example, surrounds a vehicle opening 103 in the vehicle roof 101. A cover 102 is designed to close the vehicle opening 103 in the vehicle roof 101. The cover 102 is, for example, part of a panoramic roof, a spoiler roof, a sliding roof, for example an externally guided sliding roof, and/or a sliding lifting roof, a roof that can be mounted from above, also known as a top-load roof, or a roof that can be mounted from below, also known as a bottom-load roof. The cover 102 is made of glass or a transparent plastic, for example.

The vehicle 100 further comprises a rear window 104 and a front window 105. A first main extension axis L1 extends from the rear window 104 to the front window 105. A second main extension axis L2 lies transverse to the first main extension axis L1 and extends from a first longitudinal side 106 of the vehicle, which connects the rear window 104 and the front window 105, to a second longitudinal side 107 of the vehicle opposite the first longitudinal side 106 of the vehicle, which also connects the rear window 104 and the front window 105. The first vehicle longitudinal side 106, the second vehicle longitudinal side 107, the rear window 104 and the front window 105 enclose the vehicle roof 101, the cover 102 and the frame arrangement 10. The frame arrangement 10 comprises at least one frame element 20 which extends along the first main extension axis L1. The frame element 20 is arranged on the first longitudinal side 106 of the vehicle. A further frame element 20 is arranged along the second longitudinal side 107 of the vehicle.

A first main extension plane E1 is spanned by the first main extension axis L1 and the second main extension axis L2. The first main extension plane E1 extends, for example, along the first main extension axis L1, as is usual in an operational motor vehicle. The first main extension plane E1 also extends, for example, along the second main extension axis L2, as is usual in an operational motor vehicle. The second main extension axis L2 is aligned with an intersection axis A-A. The intersection axis A-A is shown as a dotted line with two arrows indicating the viewing direction. The viewing direction runs along the first main extension axis L1.

FIG. 2 shows an exemplary embodiment of the frame arrangement 10 in a schematic sectional view along the sectional axis A-A from FIG. 1. The frame arrangement 10 comprises the frame element 20 and a first plastic guide rail 30. The frame element 20 extends along the first main extension axis L1. The frame element 20 comprises a main portion 21 arranged along the first main extension plane E1. The frame element 20 further comprises a first reinforcing portion 22 extending along the first main extension axis L1 and connected to the main portion 21. The first reinforcing portion 22 protrudes from the first main extension plane E1 along a vertical axis H1. The vertical axis H1 is, for example, perpendicular or inclined to the first main extension plane E1.

The first plastic guide rail 30 extends along the first main extension axis L1 and the vertical axis H1. The first plastic guide rail 30 at least partially surrounds the first reinforcing portion 22 for stabilizing the first plastic guide rail 30. The first plastic guide rail 30 comprises, for example, polyurethane, preferably thermoplastic. Thermoplastics used include, for example, polyethylene terephthalate (PET), polyether ether ketone (PPEK), polyamides (PA) or partially aromatic polyamides (PPA).

The first plastic guide rail 30 comprises a guide rail channel 31 for a drive cable 95 and at least one receiving channel 32 for a carriage 90. The carriage 90 is designed to be guided in the first plastic guide rail 30 and to be moved relative to the first plastic guide rail 30. The carriage 90 has, for example, a main part 91 and two side parts 92 connected thereto. The main part 91 is arranged along the first main extension plane E1 and the two side parts 92 protrude from the main part 91 along the vertical axis H1. The side parts 92 are connected to the main part 91 by a first end. In addition, the two side parts 92 each have a clamp-like holding portion 93 at a second end of the carriage 90, which is opposite the first end along the vertical axis H1. The geometry of the carriage 90 thus enables the carriage 90 to engage in the two receiving channels 32 of the plastic guide rail 30 with the holding portions 93. Alternatively, the carriage 90 engages with only one holding portion 93 in only one receiving channel 32.

The drive cable 95 is coupled to the carriage 90. The drive cable 95 is designed to transmit both tensile and shear forces to the carriage 90. In particular, the drive cable 95 is designed to be pressure-resistant.

The guide rail channel 31 is, for example, integrated into the first plastic guide rail 30 and is manufactured in one piece with the first plastic guide rail 30. For example, by means of an injection molding process. Alternatively or additionally, the guide rail channel 31 is a separate component. Alternatively, the guide rail channel 31 is manufactured by extrusion, for example, and is subsequently embedded in the first plastic guide rail 30. Alternatively, the first plastic guide rail 30 and the guide rail channel 31 are coextruded assemblies which are joined together by plastic melts of the same or different types. The guide rail channel 31 comprises polyurethane, for example, and abrasion-resistant thermoplastics are preferred. Polyethylene terephthalate (PET), polyether ether ketone (PPEK), polyamides (PA) or partially aromatic polyamides (PPA) are used as thermoplastics, for example. Alternatively or additionally, the guide rail channel 31 comprises metal.

The first plastic guide rail 30 advantageously makes it possible to create recesses or areas for other functional assemblies. Also, for example, if water drains can also be integrated into the first plastic guide rail 30 without the need for time-consuming reworking of the first plastic guide rail 30 or additional mounting by means of fasteners. It is therefore preferably intended for use in dry areas. For example, to attach wind deflectors.

The first reinforcing portion 22 and the first plastic guide rail 30 together form a unitary assembly. Accordingly, the first reinforcing portion 22 provides additional support for the first plastic guide rail 30, which creates a more stable frame arrangement 10 overall.

The first plastic guide rail 30 at least partially surrounds the first reinforcing portion 22 and/or the main portion 21 for stabilizing the first plastic guide rail 30. Alternatively, only the first reinforcing portion 22 is surrounded by the first plastic guide rail 30. The first plastic guide rail 30 is, for example, an injection-molded component and is injection-molded onto the first reinforcing portion 22 or overmolds the first reinforcing portion 22. In addition, it is also possible to overmold the main portion 21 or to overmold the first reinforcing portion 22 onto the main portion 21.

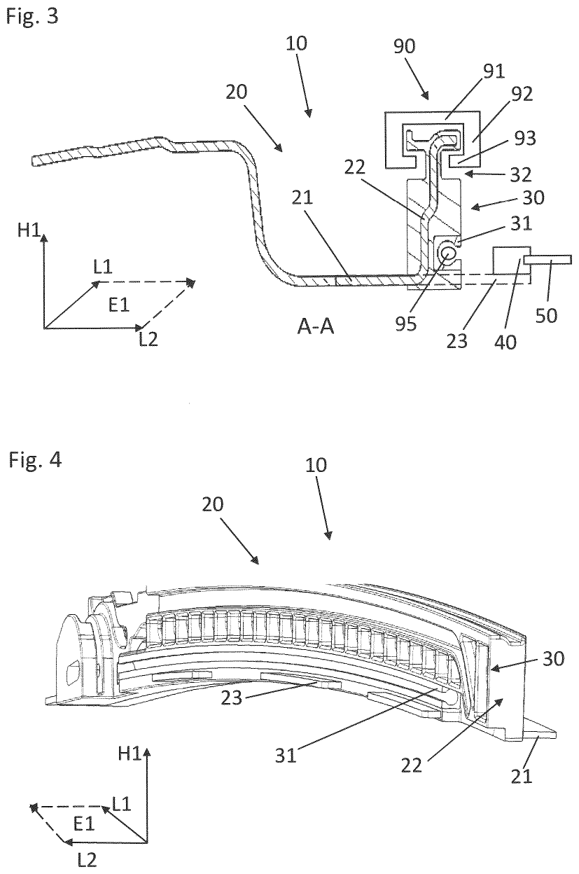

FIG. 3 shows an exemplary embodiment of the frame arrangement 10 in a schematic sectional view along the sectional axis A-A from FIG. 1. FIG. 3 shows substantially the same frame arrangement 10 as shown in FIG. 2, with the difference that the frame element 20 comprises a second reinforcing portion 23 which is connected to the main portion 21 and extends the main portion 21 along the second main extension axis L2. The second reinforcing portion 23 is suitable for accommodating a second plastic guide rail 40. The second reinforcing portion 23 is formed, for example, from the first reinforcing portion 22 of the frame element 20. For example, a part of the first reinforcing portion 22 is punched out or cut out and bent over in order to realize the second reinforcing portion 23. Additional fastening means, such as welds, rivets, screws, bolts or the like, can be dispensed with in order to realize the first reinforcing portion 22 and the second reinforcing portion 23. This simplifies the manufacture and assembly of the frame element 20.

The second plastic guide rail 40 is, for example, glued to the second reinforcing portion 23 or molded onto it by overmolding. The second plastic guide rail 40 comprises, for example, polyurethane, preferably thermoplastic. Thermoplastics used include, for example, polyethylene terephthalate (PET), polyether ether ketone (PPEK), polyamides (PA) or partially aromatic polyamides (PPA). The second plastic guide rail 40 is suitable, for example, for guiding a roller blind device 50. In FIG. 3, the roller blind device 50 is only indicated and does not represent the complete roller blind device 50. The second plastic guide rail 40 is not limited to guiding and holding roller blind devices 50. Alternatively or additionally, the second plastic guide rail 40 is suitable for accommodating and/or supporting other assemblies.

FIG. 4 shows a schematic representation of a frame element 20 according to an exemplary embodiment. The frame element 20 extends along the first main extension axis L1. The frame element 20 comprises the main portion 21, which extends along the first main extension plane E1. The first reinforcing portion 22, extends along the first main extension axis L1 and is connected to the main portion 21. The first reinforcing portion 22 protrudes along the vertical axis H1 from the first main extension plane E1. The second reinforcing portion 23 is connected to the main portion 21 and extends the main portion 21 along the second main extension axis L2. The first reinforcing portion 22 is surrounded by the first plastic guide rail 30 and is located inside the first plastic guide rail 30. The first plastic guide rail 30 at least partially surrounds the main portion 21. The first plastic guide rail 30 is stabilized by the first reinforcing portion 22. The main portion 21 additionally stabilizes the first plastic guide rail 30. The first reinforcing portion 22 and the second reinforcing portion 23 protrude alternately from the main portion 21 along the first main extension axis L1.

The guide rail channel 31 is, for example, integrated into the first plastic guide rail 30 and is manufactured in one piece with the first plastic guide rail 30. For example, by means of an injection molding process. Alternatively or additionally, the guide rail channel 31 is a separate component. Alternatively, the guide rail channel 31 is produced by extrusion and is subsequently embedded in the first plastic guide rail 30.

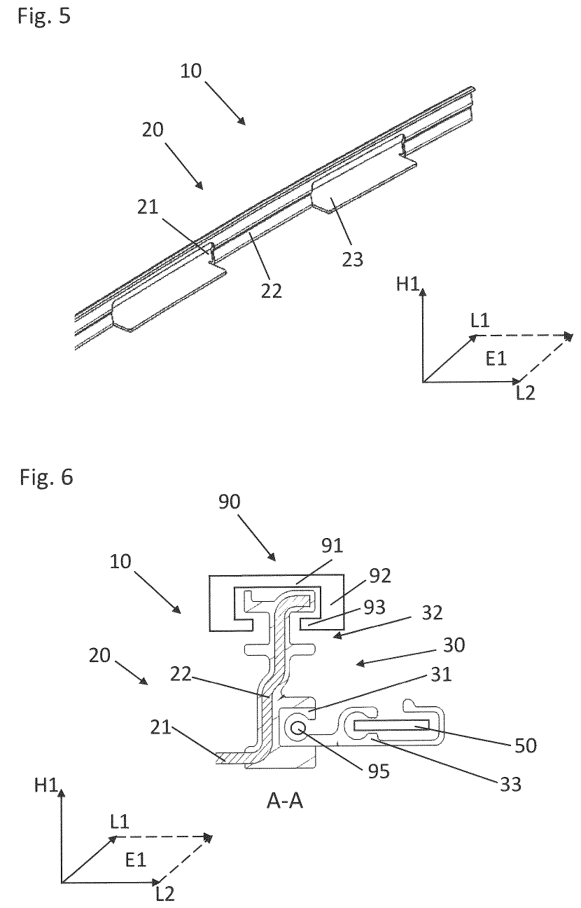

FIG. 5 shows a schematic representation of a frame element 20 according to an exemplary embodiment. The frame element 20 extends along the first main extension axis L1. The frame element 20 comprises the main portion 21, which extends along the first main extension plane E1. The first reinforcing portion 22, extends along the first main extension axis L1 and is connected to the main portion 21. The first reinforcing portion 22 protrudes along the vertical axis H1 from the first main extension plane E1. The second reinforcing portion 23 is connected to the main portion 21 and extends the main portion 21 along the second main extension axis L2. The first reinforcing portion 22 and the second reinforcing portion 23 protrude alternately from the main portion 21 along the first main extension axis L1. In the regions in which the second reinforcing portion 23 protrudes from the main portion 21 along the second main extension axis L2, the first reinforcing portion 22 is only partially present. In the areas in which the first reinforcing portion 22 protrudes from the main portion 21 along the vertical axis H1, the second reinforcing portion 23 is not present. Alternatively, in the regions along the first main extension axis L1, in which the second reinforcing portion 23 protrudes from the main portion 21, no first reinforcing portion 22 is present.

FIG. 6 shows an exemplary embodiment of the frame arrangement 10 in a schematic sectional view along the sectional axis A-A from FIG. 1. FIG. 6 shows substantially the same frame arrangement 10 as shown in FIG. 2, with the difference that the guide rail channel 31 comprises an extended region 33. The extended region 33 extends the guide rail channel 31 along the second main extension axis L2. The extended region 33 is designed to provide, for example, a guide and receptacle for a roller blind device 50. In FIG. 6, the roller blind device 50 is only indicated and does not represent the complete roller blind device 50. As a combined component that can accommodate and guide both a drive cable 95 and a roller blind device 50, assembly is simplified. The guide rail channel 31, which comprises the extended region 33, can be subsequently inserted or integrated into the first plastic guide rail 30. The extended region 33 of the guide rail channel 31 is not limited to guiding and accommodating roller blind devices 50. Alternatively or additionally, the extended region of the guide rail channel is suitable for accommodating and/or supporting other assemblies. A combination of the second reinforcing portion 23 (not shown in FIG. 6) and the extended region 33 of the guide rail channel 31 is also possible.

The extended region 33 of the guide rail channel 31 is arranged, for example, on the second reinforcing portion 23 (not shown in FIG. 6). The extended region 33 of the guide rail channel 31 is supported at least at the second reinforcing portion 23. The extended region 33 is alternatively or additionally glued to the second reinforcing portion 23 or formed by overmolding. The material of the extended region 33 comprises, for example, polyurethane.

### LIST OF REFERENCE SIGNS

10 frame arrangement
20 frame element
21 main portion
22 first reinforcing portion
23 second reinforcing portion
30 first plastic guide rail
31 guide rail channel
32 receiving channel
33 extended region
40 second plastic guide rail
50 roller blind device
90 drive cable
95 carriages
100 vehicle
101 vehicle roof
102 cover
103 vehicle opening
104 rear window
105 windshield
106 first longitudinal side of the vehicle
107 second longitudinal side of the vehicle
L1 first main extension axis
L2 second main extension axis
H1 vertical axis
E1 first main extension plane

1. A frame arrangement for a vehicle roof for supporting a deployable and displaceable cover, comprising:
a frame element, which extends along a first main extension axis, comprising a main portion lying in a first main extension plane spanned by the first main extension axis and a second main extension axis, and
a first reinforcing portion, which is connected to the main portion and projects along a vertical axis from the first main extension plane,
a first plastic guide rail with at least one receiving channel for a carriage,
wherein the first plastic guide rail extends along the first main extension axis and the vertical axis, and
wherein the first plastic guide rail at least partially surrounds the first reinforcing portion for stabilizing the first plastic guide rail.

2. The frame arrangement as claimed in claim 1, wherein the first plastic guide rail at least partially surrounds the main portion for stabilizing the first plastic guide rail.

3. The frame arrangement as claimed in claim 1, wherein the first plastic guide rail is designed as an injection-molded component.

4. The frame arrangement as claimed in claim 1, wherein the first plastic guide rail comprises a guide rail channel for a drive cable.

5. The frame arrangement as claimed in claim 4, wherein the guide rail channel is designed as an injection-molded component and is embedded in the plastic guide rail.

6. The frame arrangement as claimed in claim 4, wherein the guide rail channel is designed as an extrusion component and is embedded in the plastic guide rail.

7. The frame arrangement as claimed in claim 4, wherein the guide rail channel comprises an extended region which extends the guide rail channel along the second main extension axis and which is configured to provide a guide and receptacle for a roller blind device or an acoustic seal or an inner canopy connection.

8. The frame arrangement as claimed in claim 4, wherein the frame element comprises a second reinforcing portion connected to the main portion and extending the main portion along the second main extension axis, wherein the second reinforcing portion is arranged for stabilizing the guide rail channel.

9. The frame arrangement as claimed in claim 8, wherein the second reinforcing portion is designed to accommodate a second plastic guide rail.

10. The frame arrangement as claimed in claim 8, wherein the frame element is shaped alternately along the main extension axis, so that along the first main extension axis the first reinforcing portion and the second reinforcing portion alternately protrude at least partially from the main portion.

11. The frame arrangement as claimed in claim 1, wherein the frame element is formed of metal or comprises such a material.

12. The frame arrangement as claimed in claim 1, wherein the frame element is formed of steel or comprises such a material.

13. The frame arrangement as claimed in claim 1, wherein the first reinforcing portion partially surrounds and stabilizes the at least one receiving channel.

14. A vehicle, comprising a vehicle roof and a frame arrangement as claimed in claim 1, wherein the frame arrangement is fixedly coupled to the vehicle roof.
